(19) United States
(12) Patent Application Publication
(10) Pub. No.: US 2019/0134549 A1
(43) Pub. Date: May 9, 2019

(54) Filter Element, in Particular for Gas Filtration

(71) Applicant: MANN+HUMMEL GmbH, Ludwigsburg (DE)

(72) Inventors: Martin Klein, Bayreuth (DE); Joerg Menssen, Eschede (DE); Klaus-Dieter Ruhland, Meckenheim (DE)

(21) Appl. No.: 16/231,484

(22) Filed: Dec. 22, 2018

Related U.S. Application Data
(63) Continuation of application No. PCT/EP2017/063932, filed on Jun. 8, 2017.

(30) Foreign Application Priority Data
Jun. 28, 2016 (DE) 102016007789.1

(51) Int. Cl. B01D 46/00; B01D 46/04

(52) U.S. Cl. CPC B01D 46/0068; B01D 46/04; B01D 46/0046

(57) ABSTRACT

A filter element is provided with at least one filter medium body and a flow chamber that is at least partially enclosed by the at least one filter medium body. A distribution element is provided that distributes a flushing gas to be introduced into the flow chamber. A carrier body that forms a wall element of the wall delimiting the flow chamber is provided. The distribution element is fastened to the carrier body. A filter device is provided with a filter housing that accommodates the filter element and is further provided with a flushing gas device.

### CROSS-REFERENCE TO RELATED APPLICATIONS

This application is a continuation application of international application No. PCT/EP2017/063932 having an international filing date of 8 Jun. 2017 and designating the United States, the international application claiming a priority date of 28 Jun. 2016 based on prior filed German patent application No. 10 2016 007 789.1, the entire contents of the aforesaid international application and the aforesaid German patent application being incorporated herein by reference.

### BACKGROUND OF THE INVENTION

The invention concerns a filter element, in particular for gas filtration, with a filter medium body and a flow chamber enclosed at least partially by the filter medium body as well as with a distribution element for flushing gas which can be introduced into the flow chamber.

U.S. Pat. No. 9,108,135 B2 discloses an air filter which comprises a hollow cylindrical filter element in a filter housing which is flowed through in radial direction from the exterior to the interior by the air to be purified, wherein the purified air is discharged axially from the inwardly positioned flow chamber. A flow pipe with reduced diameter projects into the outflow side of the filter element, wherein flushing gas for cleaning off the filter medium body of the filter element is introduced through the flow pipe opposite to the outflow direction of the purified air. The flushing gas flows through the filter medium body in radial direction from the interior to the exterior so that deposits at the exterior side of the filter medium body are detached.

At the flow pipe through which the flushing gas is introduced axially into the flow chamber of the filter medium body, a flushing gas nozzle arranged at the end face is provided by means of which the flushing gas which is introduced under pressure is spread. In this way, a high cleaning performance is to be ensured across the entire axial length and the entire circumference of the filter medium body. The flushing gas nozzle comprises, distributed about its circumference, a plurality of outflow openings grouped about an axial main outflow opening and directed at an angle relative to the longitudinal axis of the filter element in the direction toward the inner wall of the filter medium body.

EP 1 547 663 A2 discloses a filter element with integrated flushing gas device which comprises a tube section, projecting into the inwardly positioned flow chamber of the filter medium body of the filter element, for introducing flushing air that impacts on an axially spaced-apart distribution element which, by means of holding legs, is held axially adjustably in the flow chamber. The tube section through which the flushing air is introduced can be axially adjusted in the flow chamber.

### SUMMARY OF THE INVENTION

The invention has the object to configure with simple constructive measures a filter element in such a way that cleaning of the filter medium body with flushing gas can be performed in an efficient way.

This object is solved according to the invention in that the distribution element is fastened to a carrier body which forms a wall element of a wall delimiting the flow chamber. The dependent claims provide expedient further embodiments.

The filter element according to the invention is used preferably for gas filtration, for example, for filtration of air, in particular in the intake manifold of an internal combustion engine of a vehicle. The filter element comprises a filter medium body which is flowed through by the fluid to be purified and at which the purification of the fluid takes place. The filter medium body encloses at least partially a flow chamber that is positioned at the clean side of the filter medium body and through which the purified fluid is discharged from the filter element.

In order to be able to clean off deposits at the raw side of the filter medium body of the filter element, a flushing gas, which flows through the filter medium body opposite to the usual purification direction, can be introduced into the inwardly positioned flow chamber enclosed by the filter medium body. The flushing gas is first introduced into the flow chamber and guided from the flow chamber farther through the wall of the filter medium body so that deposits at the raw side of the filter medium body are removed by the pressure pulses of the flushing gas. Air can be used as a flushing gas, for example.

In the flow chamber, a distribution element is provided for the flushing gas to be introduced, wherein the distribution element deflects the flushing gas stream introduced into the flow chamber toward the inner side of the filter medium body that delimits the flow chamber. The distribution element ensures an improved flow against the filter medium body at the clean side as well as flow from the clean side to the raw side so that the dirt particles deposited at the raw side are detached by the flushing gas. By means of the distribution element, in particular a uniform flow against the filter medium body at the inner side is ensured. As needed, the distribution element can also be configured in such a way that certain sections at the inner side of the filter medium body are subjected to a stronger flow. The distribution element is fastened to a carrier body that is preferably embodied separate from the distribution element and forms a wall element of a wall delimiting the inwardly positioned flow chamber. This wall is in particular a wall that is positioned opposite the outflow side of the flow chamber through which the purified fluid is discharged.

This embodiment has the advantage that in the region of the outflow side no device for attachment of the distribution element is required. The outflow side of the flow chamber can therefore be adapted, without constructive restrictions regarding the connection, to a pipe for the discharge of the purified fluid. At the same time, it is ensured that the carrier body of the distribution element, without restrictions by the outflow of the fluid, can be adapted to the carrier function for the distribution element. In that the carrier body forms a wall element of the wall delimiting the flow chamber and in particular is integrated into the wall, the flow chamber is not restricted by the carrier body so that the flow of the purified fluid in the flow chamber in the filtration operation as well as the flow of the flushing gas stream in the flushing operation are not impaired.

The carrier body is in particular embodied to be flow-tight and also integrated in a flow-tight manner into the wall of the flow chamber. However, it can be expedient to arrange a flushing gas nozzle in the carrier body via which the flushing gas can be introduced into the flow chamber. The flushing gas nozzle is embodied, for example, as a tube section, in particular a straight tube section extending in longitudinal direction of the filter element, and projects into the carrier body or passes through the carrier body. The flushing gas nozzle can be embodied, as needed, as one piece together with the carrier body, in particular in the embodiment of the carrier body as an injection molded component. However, a separate embodiment of flushing gas nozzle and carrier body is possible also.

According to an advantageous embodiment, the filter element is embodied to be hollow cylindrical and the flow chamber is formed by the interior within the hollow cylindrical filter medium body. The carrier body is arranged at an end face of the filter element and closes off the flow chamber at this end face in a flow-tight manner. Advantageously, at the end face of the filter medium body an annular end disk is arranged which closes off the filter medium body at its end face in a flow-tight manner, wherein the carrier body is integrated into the annular end disk and/or forms it at least partially. The integration is realized in particular in such a way that the transition between carrier body and end disk is flow-tight. In the hollow cylindrical embodiment of filter element and filter medium body, the outflow side of the flow chamber is arranged at the end face axially opposite the carrier body.

According to a further expedient embodiment, the distribution element is provided with holding legs by means of which the distribution element is fastened to the carrier body. The holding legs can be clipped into the carrier body, for example, in order to produce a form-fit and/or frictional connection.

In an alternative embodiment, distribution element and carrier body are embodied together as one piece.

According to a further expedient embodiment, the outer diameter of the carrier body corresponds to the inner diameter of the flow chamber in the hollow cylindrical embodiment of the filter element.

In a further advantageous embodiment, the carrier body is integrated into the wall delimiting the flow chamber, without however forming the outer side of the wall. In this embodiment, the corresponding wall is areally delimited by a further component, for example, an end disk, wherein the carrier body preferably is arranged at the inner side, facing the flow chamber, of this component.

According to yet another expedient embodiment, the distribution element has an outer contour which widens in flow direction of the flushing gas and is embodied to be conical, for example. The distribution element can comprise either a linearly extending wall surface or a non-linearly extending wall surface, for example, a convexly or concavely shaped wall surface. The non-linearly extending wall surface can optionally be combined with the conical basic shape. The outer contour which widens in flow direction has the advantage that the impacting flushing gas stream spreads out and is deflected in direction toward the inner side of the filter medium body.

According to a further expedient embodiment, the distribution element is designed as a flat impact plate against which the introduced flushing gas stream impinges to be deflected laterally.

According to yet another expedient embodiment, the carrier body and the distribution element are located at oppositely positioned wall sides of the flow chamber and are connected by a connecting element that, for example, is embodied as a flow pipe. In this embodiment, it is expedient that the flushing gas stream is introduced through the flushing gas nozzle in the carrier body and is guided through the flow pipe in the direction toward the oppositely arranged distribution element at which bouncing off and deflection of the flushing gas stream in the direction toward the inwardly positioned wall side of the filter medium body are realized.

According to yet another expedient embodiment, at least two separate distribution elements are arranged in the flow chamber which are in particular positioned one after another in flow direction of the flushing gas stream. The introduced flushing gas stream impinges thus first on the first distribution element and is deflected thereat. A portion of the flushing gas stream impinges subsequently directly or indirectly on the second distribution element at which also a deflection takes place. In this way, it is possible to achieve a uniform inflow at the inner side of the filter medium body, for example, across the entire axial length of the flow chamber.

In case that two or more distribution elements are arranged, it is sufficient that only one distribution element is attached to the carrier body while the second distribution element can be attached to a further component of the filter element, for example, at a center tube at the inner side of the filter medium body which lines the flow chamber.

### BRIEF DESCRIPTION OF THE DRAWINGS

Further advantages and expedient embodiments can be taken from the further claims, the figure description, and the drawings.

FIG. 1 shows a filter device for gas filtration including a flushing device in exploded illustration.

FIG. 2 shows a hollow cylindrical filter element with a carrier body, arranged at an end face, for a distribution element of the flushing device in perspective view.

FIG. 3 shows a section in longitudinal direction through the filter element according to FIG. 2 with the distribution element for flushing gas arranged in the inwardly positioned flow chamber.

FIG. 4 shows in perspective view an annular end disk, a carrier body to be inserted into the end disk, and a distribution element to be connected to the carrier body.

FIG. 5 shows an end disk, carrier body, and distribution element in a further perspective view.

FIG. 6 shows carrier body and distribution element in the mounted state.

FIG. 7 shows a distribution element in an embodiment variant.

FIG. 8 shows a distribution element in a further embodiment variant.

FIG. 9 shows a distribution element in yet another embodiment.

FIG. 10 shows a section in longitudinal direction through a filter element with two distribution elements positioned one after the other in the interior flow chamber.

FIG. 11 shows a filter element in a further embodiment variant in which the carrier body and the distribution element are arranged at opposite end faces and are connected by a flow pipe.

FIG. 12 shows a filter device in an embodiment variant in which a pressure tank of the flushing device is arranged at the filter housing.

FIG. 13 shows a filter device in a further embodiment variant in which a valve for regulating the flushing gas stream is arranged separate from the pressure tank of the flushing device.

In the Figures, same components are provided with same reference characters.

### DESCRIPTION OF PREFERRED EMBODIMENTS

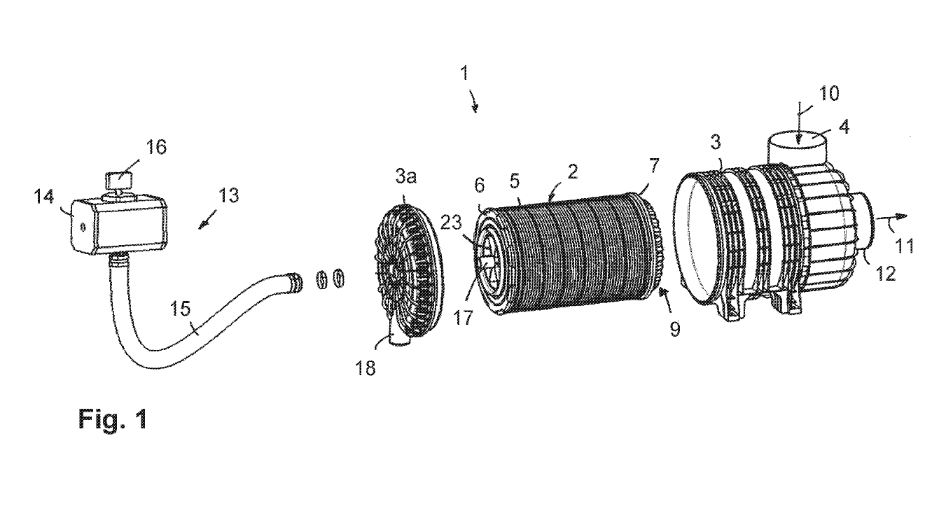

The filter device 1 illustrated in FIG. 1 is used for gas filtration, in particular for an air filter in an internal combustion engine. The filter device 1 comprises a hollow cylindrical filter element 2 that is insertable into a filter housing 3 which can be closed off by a housing cover 3a. Arranged upstream of the filter element 2 in the filter device 1, a tangential pre-separator 4 is provided by means of which coarser dirt particles are separated from the gas stream to be purified before the gas stream flows in radial direction from the exterior to the interior through the filter element 2.

The filter element 2 comprises a hollow cylindrical filter medium body 5 at which the filtration takes place, wherein at the filter medium body 5 a respective end disk 6, 7 is arranged at the two end faces. The hollow cylindrical filter medium body 5 encloses an inwardly positioned flow chamber 8 (FIG. 3) that forms the clean side from which the purified fluid is axially discharged through the outflow side 9. The flow of the fluid to be purified is illustrated by the arrows 10 and 11. First, the unpurified fluid is radially introduced according to arrow 10 into the tangential pre-separator 4; after completion of the filtration, the purified fluid is discharged axially through a flow socket 12 at the filter housing 3 in direction of arrow 11. The outflow side 9 of the filter element 2 is contacting the flow socket 12 in the mounted state.

A flushing device 13 is correlated with the filter element 2 and is a component of the filter device 1 and comprises a pressure tank 14, a pressure line 15, a valve 16 as well as a flushing gas nozzle 17. Through valve 16 which is located at the pressure tank 14, the flushing gas stream, which is introduced through the pressure line 15 and the flushing gas nozzle 17 into the inwardly positioned flow chamber of the filter medium body 5, is regulated. In the flushing operation, flow of the pressurized flushing gas, in particular air, through the filter medium body 5 is carried out opposite to the filtration direction of the filtration operation. After introduction into the inwardly positioned flow chamber in the filter medium body 5, the flushing gas flows in radial direction from the interior to the exterior through the filter medium body so that deposits at the outwardly positioned raw side of the filter medium body 5 are detached. The detached deposits can be removed subsequently through a discharge socket 18 which is provided at the housing cover 3a.

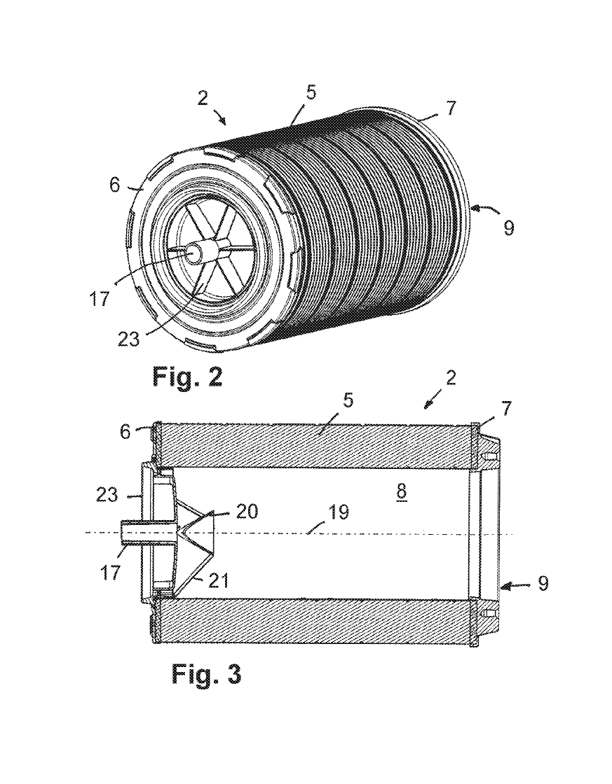

As can be taken from FIG. 1 in connection with FIGS. 2 through 6, the flushing gas nozzle 17 through which the flushing gas is introduced into the inwardly positioned flow chamber 8 in the filter medium body 5 is arranged at a carrier body 23 at which also a distribution element 20 is fastened which is located in the inwardly positioned flow chamber 8. The tubular flushing gas nozzle 17 is preferably embodied as one piece together with the carrier body 23. The distribution element 20 is advantageously embodied as a separate component that is connected by holding legs 21 to the carrier body 23 at the inner side. The tubular flushing gas nozzle 17 and the distribution element 20 for the flushing gas are positioned coaxially to the longitudinal axis 19 (FIG. 3) of the filter element 2.

The distribution element 20 has a conical shape and widens in the flow direction of the flushing gas so that the pointed end of the cone shape is facing the flushing gas nozzle 17. The flushing gas which is entering through the flushing gas nozzle 17 impinges on the conically shaped wall surface of the distribution element 20 and is deflected by it in the direction toward the inner side of the filter medium body 5. The tip of the conically shaped distribution element 20 adjoins immediately the outflow side of the flushing gas nozzle 17 which, at the outer side, projects past the carrier body 23 but is flush with the inwardly positioned carrier body side at the inner side.

The carrier body 23 is embodied disk-shaped and is received in the annular end disk 6 and connected fluid-tightly therewith. The carrier body 23 forms a wall element for flow-tight closure of the flow chamber 8 at the end face of the filter element 2. The carrier body 23 is located at the filter element 2 at the end face which is oppositely positioned relative to the outflow side 9 for the purified fluid. Flow is possible only for flushing gas through the flushing gas nozzle 17 at this end face of the filter element 2.

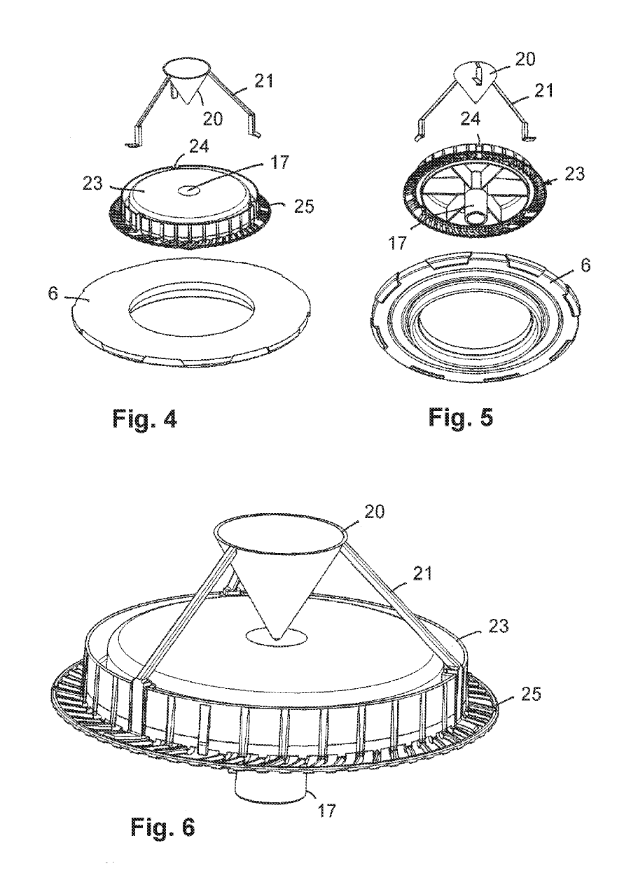

The distribution element 20 comprises in total, for example, three holding legs 21 distributed about the circumference which at their ends are angled and with these angled ends project into correlated form-fit recesses 24 (FIGS. 4, 5) at the circumferential side of the carrier body 23. The carrier body 23 comprises a radially projecting collar 25 which is located at the side facing away from the distribution element 20 and which, in the mounted state, is preferably contacting the filter medium body 5 and, further preferred, is embedded with form fit in the end disk 6, for example, made of polyurethane. The outer diameter of the carrier body 23 is matched to the inner diameter of the inwardly positioned flow chamber 8 so that the end face opening of the flow chamber is filled out completely by the carrier body 23. The diameter of the flushing gas nozzle 17 and also the maximum outer diameter of the conical distribution element 20 are significantly smaller than the inner diameter of the flow chamber 8.

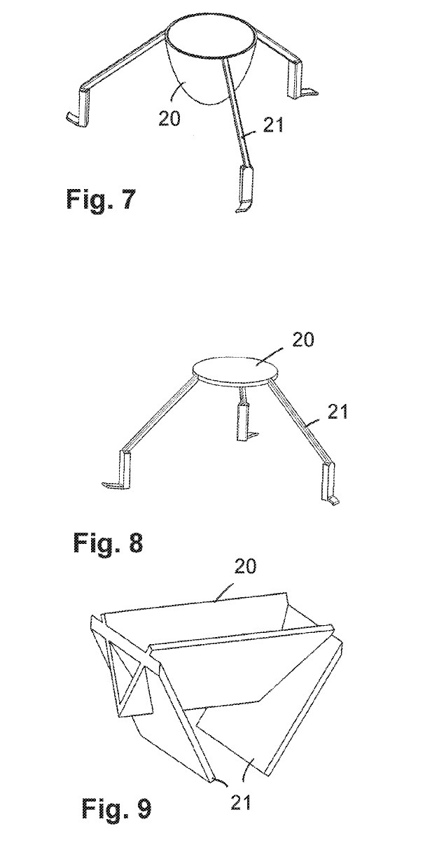

The conically embodied distribution element 20 comprises a linearly extending wall surface against which the introduced flushing gas stream impinges. In the embodiment according to FIG. 7, an embodiment variant is illustrated, on the other hand, in which the distribution element 20 is also of a conical shape but comprises a non-linearly extending, outwardly convexly curved wall surface.

In the embodiment according to FIG. 8, the distribution element 20 is embodied as a flat, disk-shaped impact plate that can be connected by three holding legs 21 with the carrier body.

In the embodiment according to FIG. 9, the distribution element 20 is formed of two plates which are forming an angled trough, wherein the angled tip of the two plates is facing the flushing gas nozzle and, in this way, the plates widen angularly in the flow direction of the flushing gas. The attachment of the distribution element 20 at the carrier body is realized, for example, by means of at least two or three holding parts 21 which are arranged laterally at the angularly joined plates and are also each formed in a plate shape. The holding parts 21 extend with their free end toward each other and are therefore also positioned at an angle relative to each other, but in an angle plane which is displaced by 90° relative to the angle plane of the distribution element 20. The free end of the two plate-shaped holding parts 21 defines a small gap through which the flushing gas can pass. The plate-shaped holding elements 21 serve thus also for guiding and conducting the flushing gas stream.

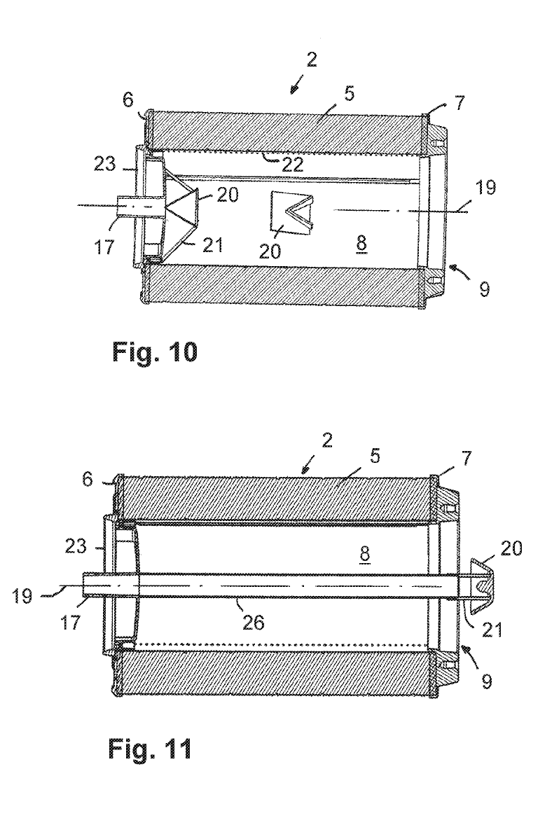

In the embodiment according to FIG. 10, two distribution elements 20 are positioned one after another in the inwardly positioned flow chamber 8 of the filter medium body 5 in axial flow direction of the flushing gas. The first distribution element 20 is of a conical shape, as in the embodiment according to FIG. 3, and is connected by holding legs 21 with the carrier body 23 which closes off an end face. The oppositely positioned end face forms the outflow side 9 via which the purified fluid is axially discharged in the filtration operation.

In the inwardly positioned flow chamber 8, axially spaced apart from the first distribution element, a second distribution element 20 is provided that in particular is held at a central tube 22 which is located at the inner side of the filter medium body 5 and lines the flow chamber 8. The second distribution element 20 can be embodied in particular as shown in FIG. 9. The second distribution element 20 comprises, for example, an impact plate as well as an angled element that is arranged at the impact plate and widens in the direction of the axially incoming flushing gas. The second distribution element 20 is located approximately axially at the center of the filter element 2. By means of the second distribution element 20, a further spreading out of the introduced flushing gas stream in the direction toward the inner side of the filter medium body is achieved.

In the embodiment according to FIG. 11 that also concerns, like FIG. 10, a hollow cylindrical filter element 2, the distribution element 20 is arranged outside of the inwardly positioned flow chamber 8 as well as adjacent to the outflow side 9. At the side which is positioned axially opposite the outflow side 9, the end face of the filter element 2, as in the preceding embodiments, is closed off flow-tightly by the disk-shaped carrier body 23 into which the tubular flushing gas nozzle 17 is integrated via which the flushing gas is axially introduced under pressure. A flow pipe 26 adjoins the flushing gas nozzle 17 and extends across the axial length of the flow chamber 8 and projects at the oppositely positioned outflow side 9 from the filter medium body 5 and at this side is carrier of the distribution element 20, located outside of the filter medium body and of the flow chamber 8. The flushing gas is guided through the flushing gas nozzle 17 into the axially extending flow pipe 26 and impinges at the outflow side 9 against the distribution element 20 at which a deflection of the flushing gas stream with simultaneous spreading back into the inwardly positioned flow chamber 8 in the direction toward the inner side of the filter medium body 5 is realized.

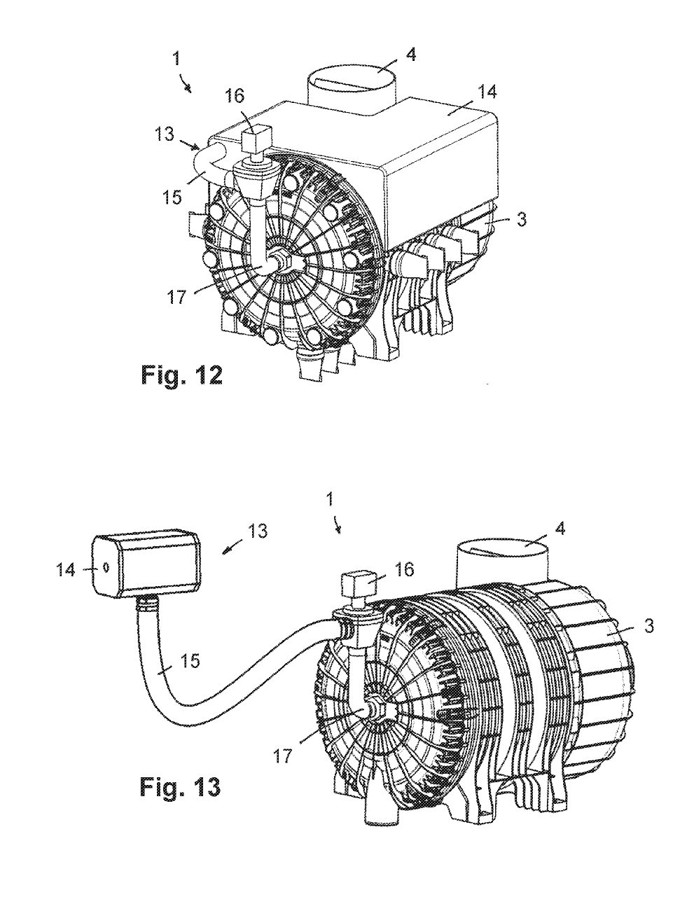

In the embodiment according to FIG. 12, the flushing device 13 at the filter device 1 is illustrated in an embodiment variant in which the pressure tank 14 of the flushing device 13 is arranged at the filter housing 3 of the filter device. A pressure line 15 with an integrated valve 16 for regulating the flushing gas stream branches off the pressure tank 14. A tube section with the flushing gas nozzle 17 extends from the valve 16 to the end face of the filter device.

In the embodiment according to FIG. 13, the filter device is embodied similar to FIG. 1 but the flushing device 13 is illustrated in an embodiment variant in which the valve 16 is not seated immediately at the pressure tank 14 but at the transition between the pressure line 15, branching off the pressure tank 14, and the tube section with the flushing gas nozzle 17.

What is claimed is:

1. A filter element comprising:
at least one filter medium body;
a flow chamber at least partially enclosed by the at least one filter medium body;
a wall delimiting the flow chamber;
a distribution element configured to distribute a flushing gas to be introduced into the flow chamber;
a carrier body forming a wall element of the wall delimiting the flow chamber, wherein the distribution element is fastened to the carrier body.

2. The filter element according to claim 1, wherein the filter element is hollow cylindrical and the flow chamber forms an interior in the at least one filter medium body, wherein the carrier body is arranged at an end face of the at least one filter medium body.

3. The filter element according to claim 2, wherein the wall delimiting the flow chamber comprises an annular end disk arranged at the end face of the at least one filter medium body, wherein the carrier body is integrated into the annular end disk.

4. The filter element according to claim 1, further comprising a flushing gas nozzle received in the carrier body, wherein the flushing gas nozzle is configured to introduce the flushing gas into the flow chamber.

5. The filter element according to claim 1, wherein the distribution element is arranged at a side of the flow chamber that is positioned axially opposite an outflow side of the flow chamber.

6. The filter element according to claim 1, wherein the distribution element comprises holding legs and the distribution element is attached by the holding legs to the carrier body.

7. The filter element according to claim 1, wherein the distribution element comprises an outer contour widening in a flow direction of the flushing gas.

8. The filter element according to claim 7, wherein the distribution element is conical.

9. The filter element according to claim 1, wherein the distribution element comprises a linearly extending wall surface.

10. The filter element according to claim 1, wherein the distribution element comprises a non-linearly extending wall surface.

11. The filter element according to claim 10, wherein the non-linearly extending wall surface of the distribution element is a convex wall surface or a concave wall surface.

12. The filter element according to claim 1, wherein the distribution element is a flat impact plate.

13. A filter device comprising:
a filter housing;
a filter element comprising at least one filter medium body; a flow chamber at least partially enclosed by the at least one filter medium body; a wall delimiting the flow chamber; a distribution element configured to distribute a flushing gas to be introduced into the flow chamber; and a carrier body forming a wall element of the wall delimiting the flow chamber, wherein the distribution element is fastened to the carrier body;
wherein the filter element is disposed in the filter housing.

14. The filter device according to claim 13, further comprising a flushing gas device configured to introduce the flushing gas into the flow chamber.

15. The filter device according to claim 13, further comprising a tangential pre-separator arranged upstream of the at least one filter medium body of the filter element.
